(19) United States
(12) Patent Application Publication
(10) Pub. No.: US 2020/0049874 A1
(43) Pub. Date: Feb. 13, 2020

(54) AMBIENT FIBER LIGHTING SYSTEMS AND METHODS

(71) Applicant: LEONI Kabel GmbH, Nurnberg (DE)

(72) Inventor: Dirk Eckardt, Coburg (DE)

(73) Assignee: LEONI Kabel GmbH, Nurnberg (DE)

(21) Appl. No.: 16/100,844

(22) Filed: Aug. 10, 2018

(51) Int. Cl. F21V 8/00; G02B 6/02; G02B 1/04; C03C 25/104

(52) U.S. Cl. CPC G02B 6/0006; G02B 6/02342; G02B 6/02338; C03C 25/104; G02B 6/02033; G02B 1/048

(57) ABSTRACT

Optical fiber systems and related methods are provided. The optical fiber systems include at least one optical fiber and at least one light source. The optical fibers include a core, a cladding, and a jacket. Scattering structures are dispersed within the cladding. The optical fibers are configured to scatter light by way of the scattering structures away from the core to emit radial lighting along the length of the optical fibers.

### FIELD OF THE INVENTION

This disclosure relates generally to a light emitting optical fiber. In particular, this disclosure relates to side-light emitting optical fibers for emitting radial lighting.

### BACKGROUND OF THE INVENTION

Optical fibers have been implemented for a variety of light transmitting purposes. For example, optical fibers are well known for transmitting light from a light source to a delivery location. Such fibers may be implemented in a fiber-optic communication system to deliver light from a source (e.g., a cable provider) to a destination (e.g., a user's set-top box). As compared to more traditional light transmitting means (e.g., glass tubes), optical fibers are often cheaper, thinner, more flexible, and more compact.

Such optical fibers have been designed to efficiently transmit light from a source to a destination with minimal scattering. However, many potential applications exist where emitting light radiantly (e.g., radially along the length of the fiber) would be advantageous. For example, radiant lighting is desirable in certain biological applications, ambient lighting, lighted signs, wearable devices, etc. It would be advantageous to be able to use optical fibers for such applications.

Accordingly, there is a need for optical fibers designed to radially emit light in a variety of applications. Such fibers would provide cheap, flexible, and compact light emitting devices elements that are tailored for specific applications.

### SUMMARY OF THE INVENTION

Various illustrative embodiments of the present disclosure provide a light emitting system and related methods. In accordance with one aspect of an illustrative embodiment of the present disclosure, the light emitting system may include at least one optical fiber and at least one light source.

At least one of the optical fibers may comprise a central core, a cladding and a jacket. At least one of the fibers may have a diameter that ranges from approximately 400 μm to 5 mm. The core may be a fused silica core made from high-purity silica. The cladding may comprise a polymer and a plurality of light scattering structures. The polymer of the cladding may comprise an acrylic polymer and the light scatter structures may comprise aluminum oxide particles. The aluminum oxide particles may be dispersed within the acrylic polymer.

The light scattering structures of the cladding cause light input into the optical fiber to radially scatter out of the fiber. According to embodiments, the cladding uniformly scatters input light radially around the optical fiber (i.e., at 360° around the fiber) along the length of the fiber. The uniform radial scattering may also be constant along the length of the optical fiber. In this way, the optical fibers of the present disclosure may be referred to as side-light emitting or “ambient light” optical fibers.

According to embodiments, in order to reduce and/or eliminate bright spots (e.g., due to bending of the fiber) the scattering attenuation (i.e., scattering due do the scatter particles) caused by the scattering structures is greater than or equal to the scattering attenuation due to bending of the optical. Thus, any scattering due to bending will be compensated for by the scattering of the cladding.

The jacket may comprise a polymer. The polymer of the jacket may be a transparent plastic. The transparent plastic may comprise ethylene tetrafluoroethylene (ETFE) (e.g., Tefzel®), Nylon, PVC, PA, acrylate polymers or other suitable translucent/transparent polymers.

The at least one light source may comprise a halogen light source, a metal halide light source, a laser light source, a light emitting diode (LED), or other suitable light emitting devices. The type and wavelength of the light source may be selected according to a desired application for the optical fiber(s).

The at least one light source may be coupled to at least one of the optical fibers. According to embodiments, the light source is directly coupled to an input end of at least one of the optical fibers using suitable housing and attachment means. According to alternative embodiments, the light source is separated from an input end of at least one of the optical fibers by a distance.

Methods of making the optical fibers may include (i) growing a fused-silica based preform; (ii) drawing the preform to create a fused-silica glass core (iii) disposing a cladding on top of the glass core; and (iii) disposing a jacket on top of the cladding.

### BRIEF DESCRIPTION OF THE DRAWINGS

The following description, given by way of example and not intended to limit the invention to the disclosed details, is made in conjunction with the accompanying drawings, in which like references denote like or similar elements and parts, and in which:

FIG. 1 illustrates two examples of prior art light transmitting systems;

FIG. 2 is a lateral, cross-sectional view of an embodiment of an optical fiber of a light emitting system of the present disclosure;

FIG. 3 is a longitudinal, cross-sectional view of an embodiment of an optical fiber of a light emitting system of the present disclosure.

### DETAILED DESCRIPTION

Detailed embodiments of the present a light emitting system, and methods are disclosed herein; however, it is to be understood that the disclosed embodiments are merely illustrative of the a light emitting system, and methods that may be embodied in various forms. In addition, each of the examples given in connection with the various embodiments of the systems and methods are intended to be illustrative, and not restrictive. Further, the drawings and photographs are not necessarily to scale, and some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present light emitting system, and methods.

With reference to FIG. 2, an embodiment of an optical fiber 110 of the present disclosure is illustrated. The optical fiber 110 may include a central core 112, a cladding 114 disposed on and surrounding the core, and a jacket 120 disposed on and surrounding the cladding. The illustrative embodiment of FIG. 2 is non-limiting and optical fibers within the scope of this disclosure may be modified.

According to an embodiment, core 112 may be made from fused silica. According to a preferred embodiment, the core may be made from pure silica. Methods of manufacturing the core, which are described in more detail below, result in the creation of a pure, fused-silica glass core. The core may have a diameter that ranges from approximately 100 μm to 1500 μm.

Since the core does not include scattering structures any light that is input into the core is directed along a straight path. As further described below, only when light reaches the cladding, and in particular scattering structures 118, does light scatter, and thus emit from the side of the optical fiber.

According to an embodiment, cladding 114 comprises a polymer substrate 116 and a plurality of light scattering structures 118. The polymer substrate 116 of the cladding may comprise a translucent polymer, for example, an acrylic polymer and the light scatter structures 118 may comprise metallic particles, for example, aluminum oxide (AlO₂) particles and/or titanium oxide particles (TiO₂). According to further embodiments, light scatter structures 118 may comprise other light reflecting particles, for example, silicon dioxide particles (SiO₂). The light scatter structures 118 may be dispersed within the acrylic polymer substrate 116. According to alternative embodiments, polymer substrate 116 may comprise a combination of (i) 2-(perfluorohexyl)ethyl methacrylate, (ii) 2-propenoic acid, 2-methyl, 2-ethyl-2-[[(2-methyl-1-oxo-2-propenyl)oxy]methyl]-1,3-propanediyl ester, (iii) methanone, (1-hydroxycyclohexyl)phenyl-, (iv) Phenol, 2.6bis(1,1-dimethylethyl)-4-methylphenol, and (v) polyperfluoroEthoxymethoxy Difluoro Ethyl PEG Ether. According to further embodiments, polymer substrate 116 includes a translucent, low index, curable polymer, such as silicone.

According to embodiments, light scatter structures 118 may be randomly dispersed within polymer substrate 116. According to alternative embodiments, light scatter structures 118 may be dispersed within polymer substrate 116 with a regular pattern. Regardless of the specific orientation, light scatter structures 118 may be generally homogenously dispersed within polymer substrate 116. Such homogeneity helps to ensure that optical fiber 110 radially emits light along the entire length of the fiber at a constant or near constant luminance.

The cladding may have a thickness of approximately 20 μm to 1700 μm. The refractive index of the cladding may be lower than that of the core, which ensures that light is adequately scattered radially out of the fiber.

According to an embodiment, jacket 120 may comprise a polymer. The polymer of the jacket may be a transparent plastic. The transparent plastic may include ethylene tetrafluoroethylene (ETFE). ETFE provides the advantage of being a highly transparent material while also be easy to clean during maintenance. The jacket may have a thickness that ranges from approximately 300 μm to 5 mm. According to alternative embodiments, jacket may comprise Nylon, PVC, PA, an acrylate polymer, other suitable polymers, or combinations thereof.

According to embodiments, the allowed bending radius of optical fibers 110 may range from approximately 30 to 400 mm depending upon the specific dimensions of the core, cladding, and jacket. Such a range of allowable bending radii provide the optical fiber with the unique ability to be formed into a variety of shapes while still proving homogenous emission of light at 360° along the entire length of the fiber.

According to embodiments, optical fiber 110 has a numerical aperture (NA) ranging from 0.37 to 0.5. According to a preferred embodiment, optical fiber 110 has an NA of 0.49.

Methods of making the optical fiber 110 of the light emitting system 100 will now be described.

According to embodiments, silicon tetrachloride (SiCl₄), a highly pure, colorless, and highly moisture-sensitive liquid, is subject to flame-hydrolytic decomposition by way of a hydrogen-oxygen flame. For example, liquid SiCl₄ is subjected to (e.g., sprayed through) a hydrogen-oxygen flame, which exhibits extremely high temperatures (e.g., >2700K). The reaction that takes place between the liquid SiCl₄ and the hydrogen-oxygen flame creates particles of silica (SiO₂). Through the spraying process, the silica particles are deposited onto a rotating substrate. Due to the high temperatures of the flame, the silica particles are capable of fusing together on the rotating substrate. By continuously carrying out the above steps, a synthetic, fused-silica glass cylinder is “grown” on the rotating substrate. This grown glass may take the form of a preform. Since the silica particles created by way of the above process are highly pure, the resulting preform is similarly highly pure, and therefor has minimal optical absorption properties. These properties are similarly imparted to central core 110.

Once the preform has been grown, core 110 is created by subjecting the preform to a drawing process, for example, drawing by way of a draw tower. The draw tower may include a holding a feeding mechanism for drawing the preform to a desired diameter (e.g., 100 μm to 1500 μm). According to embodiments, a ceramic form is used for guiding the preform to the draw tower. The ceramic form may also be used, according to embodiments, for blasting separate preforms by vacuum. Once the preform is fully drawn, core 110 may be subject to a solarization procedure. Alternatively, the preform may be subjected to a solarization procedure during the drawing process. Such a core 110, created by way of the above method, is solarization resistant to UV light with wavelengths at or below approximately 240 nm.

Additionally, since a byproduct of the above method is gaseous hydrogen chloride, a gas exhaust system is implemented to capture said hydrogen chloride for further isolation and neutralization.

According to embodiments, methods of manufacturing cladding 114 may include mixing particles or pellets of a polymer and particles that include light scattering structures 118. According to preferred embodiments, nano or micro particles that include the light scattering structures are mixed with a radiation curable acrylate. Predetermined amounts of these particles/pellets may be mixed together in a two-component mixer. The two-component mixer may include a funnel-type structure, where mixing of the particles/pellets is carried out in the funnel-type structure. By including such a funnel-type structure a more homogenous admixture is obtained.

According to embodiments, a dosing machine may be to use during an extrusion process to handle the admixture of the particles/pellets. According to alternative embodiments, a gravimetric dosing machine (based on the weight of the material) or a monomeric machine (based on the volume of the screw revolution) may be used. When a dosing machine is employed, a machine to generate the mixture of particles, which may take the form of a dumper mixing machine or twin screw machine may also be employed.

Once the admixture is adequately mixed the particles/pellets may be fed through an extruder and extruded through a die. This results in the creation of a hollow tube-like structure, which includes polymer substrate 116 and a plurality of light scattering structures 118.

Cladding 114 may be applied (e.g., coated) onto core 112. For example, cladding 114 may be co-extruded with core 110 (e.g., the cladding and the preform are co-drawn). Alternatively, cladding 114 may be extruded separate from the core 110 and may be adhered to the core by a separate process.

According to embodiments, methods of manufacturing jacket 120 may include performing an extrusion process of polymer particles through a die of an extruder. According to embodiments, bubble formation during such an extrusion process may be minimized and/or prevented by way of a modified high temperature extrusion process using an acrylate polymer.

Jacket 120 may be applied (e.g., coated) onto cladding 114. For example, jacket 120 may be co-extruded with cladding 114. Alternatively, jacket 120 may be extruded separate from cladding 114 and may be adhered to the cladding by a separate process.

According to embodiments, at least one of the core 112 and cladding 114 is silanized. This increases the adhesion between the layers (i.e., core, cladding, and jacket) of optical fiber 110.

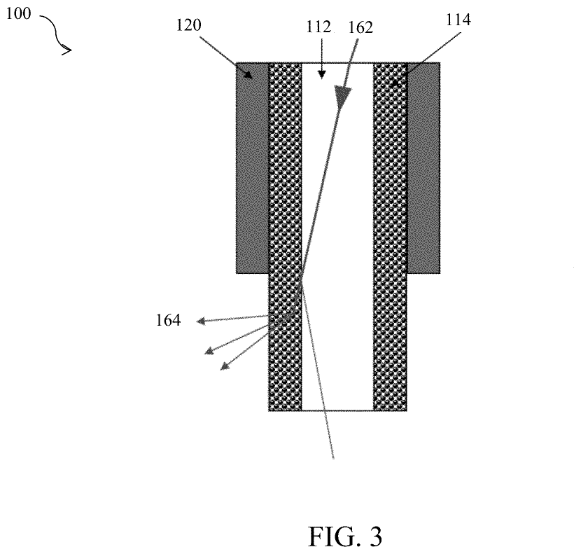

A light source 160 may be coupled to at least one of the optical fibers 110. With reference to FIG. 3, an embodiment of an optical fiber 110 scatting light of the present disclosure is illustrated. Input light 162 that is emitted from light source 160 enters optical fiber 110 at a distal end. As described above, core 112, which may take of form of a pure, fused-silica core, includes no scattering elements. Such a core structure allows input light to be directed in a linear path as it passes through the length of the core. Once the input light comes into contact with cladding 114 it either reflects back into the core or scatters toward jacket 120 and out of the optical fiber in a radial manner. The amount of light that scatters radially, as compared to the amount of light reflected back into the core, is controlled such that the amount of light emitted radially along the length of the optical fiber is generally kept constant. Such control, as further described below, is predominantly due to the structure of cladding 114.

According to embodiments, when input light 162 contacts cladding 114 it impinges upon at least one of the scattering structures 118. This causes the input light to be directed though the jacket 120 and out of optical fiber 110 in a radial direction. In this way, the optical fibers of the present disclosure act as a side-light emitting optical fiber, also referred to as an “ambient fiber.”

By placing light scattering particles 118 in the cladding, as opposed to the core, the resulting optical fiber may be manufactured more easily since modifications to the core (or its preform) are omitted. Further to this, by adding or removing a quantity of particles or pellets of the polymer and particles that include light scattering structures 118 during formation of the cladding, adjustments to the light scattering properties of the resulting fiber may be achieved more easily and may be more readily controlled, as compared to the prior art.

As discussed above, jacket 120 may be made from a transparent material.

According to embodiments, the transparent material is a transparent polymer material. According to preferred embodiments, the transparent polymer material is ETFE. According to alternative embodiments, jacket may comprise Nylon, PVC, PA, other suitable polymers, or combinations thereof. The material of jacket 120 may be selected such that light scattered by the cladding passes through jacket 120 in a linear fashion (i.e., jacket 120 does not further scatter or refract the light). Additionally, the material of jacket 120 is selected such that the resulting optical fiber 110 is chemically resistant, waterproof, and easily cleaned.

The resulting light emitting system 100 is configured to emit different types of light (e.g., visible, UV, IR, etc.) radially along the length of optical fiber(s) 110. Additionally, the light emitting system 100 is highly flexible, compact, and may operate in a wide range of environments (e.g., in temperatures ranging from approximately −40° C. to 150° C., in wet environments, etc.). Due at least in part to its flexibility and resistance to light loss from bending, light emitting system 100 may be used to emit homogenous light in a variety of shapes. Additionally, light emitting system 100 is designed such that it may be attached to a variety of surfaces, which allows light emitting system 100 to be implemented for an array of desired purposes.

### UV Sterilization System

UV light is generally known for its ability to sterilize aqueous solutions. For example, microorganisms that may be present in a aqueous solution are neutralized when exposed to certain levels of UV radiation. Conventional methods for sterilizing such solutions include transmitting UV light through large glass tubes submerged in a solution, as well a directly placing UV lamps within such a solution. Since UV sterilization adds nothing to the solution (e.g., chemicals) besides light, UV sterilization provides numerous safety advantages over more traditional chemical approaches.

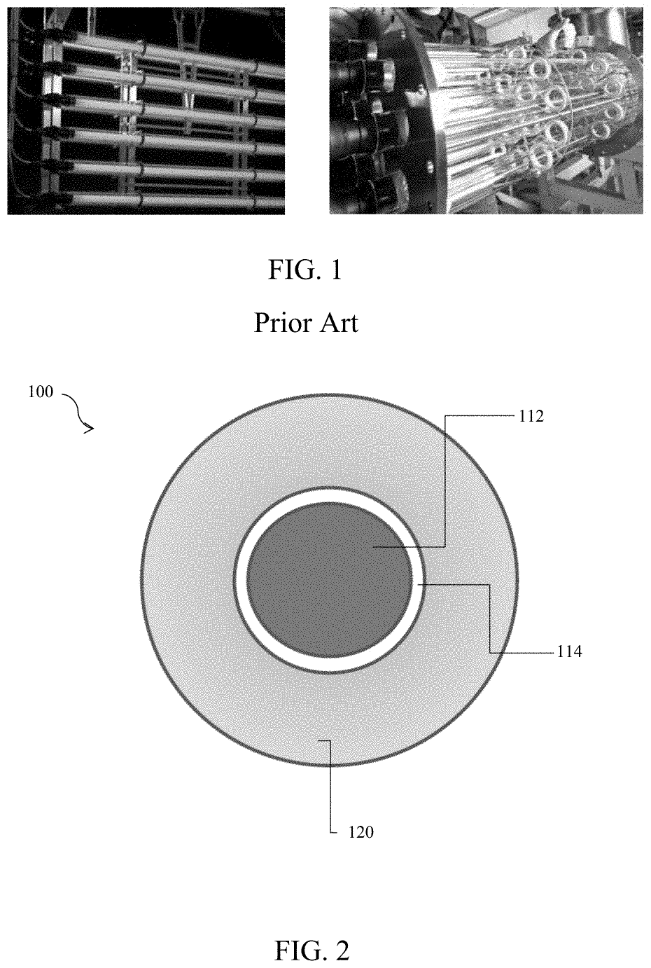

As UV sterilization is much safer than traditional chemical approaches, a growing number of wastewater treatment plants have implemented such a technique. However, known methods typically implement very large, costly, and inefficient systems to carry out UV sterilization. As illustrated by FIG. 1, prior art UV sterilization systems often include a an array of large glass tubes. Such systems consume massive amounts of energy, need frequent replacement and maintenance, and are not completely effective at sterilizing wastewater. Due to their large nature and rigidity, such systems can only be implemented in very large tanks or pools.

Optical fibers, as compared to glass tubes, are more cost efficient, compact, and flexible. Prior art UV sterilization systems are not designed with consideration of optical fibers. There remains a need for a UV sterilization system that implements optical fibers so as to reduce manufacturing costs and energy requirements, and increase efficiency, creating a flexible, compact, low-maintenance, and cost-effective system.

According to embodiments, a UV sterilization system 200 of the present disclosure may include optical fiber 210 and light source 260, which may be similar or the same as optical fiber 110 and light source 160. Optical fiber 210 may include a core 212, a cladding 214, and a jacket 220. Core 212, cladding 214, and jacket 220 may be same as described above with regard to core 112, cladding 114, and jacket 120. In this way, optical fiber 210 generally take the same form as optical fiber 110.

Methods of making core 212 may be the same or similar to core 112, as described above. However, core 212 may be subject to additional steps such that the method of making core 212 results in a fused, silica based core that is solarization resistant (e.g., resistant to darkening due to UV light exposure) below approximately 245 nm.

For example, it is known that UV light may damage a glass fiber. A known phenomenon that arises during or after laser irradiation with a high energy density, such as with UV irradiation, is called “compaction”. This effect manifests itself in a local increase in density, which leads to a rise in the refractive index and, thus, degradation of the optical fiber. When irradiating with a linearly polarized UV laser, a radially asymmetric anisotropic density and refractive-index change of a quartz glass may also observed.

According to embodiments, and in order to remedy the above drawbacks, core 212 may be subjected a UV-radiation procedure and/or a temperature treatment procedure, such that core 212 is solarization resistant, and thus, less likely to degrade from irradiation with UV light. The UV-radiation procedure may include a single-stage irradiation procedure. The temperature treatment procedure may include a single or multi-stage temperature treatment. These steps may be conducted during a drawing process of the core or after the core has been drawn and formed.

According to a preferred embodiment of the temperature treatment procedure, core 212, as it is formed during the drawing process, is placed in an oven and heated to approximately 1170° C.±40° C. for at least two hours. Subsequently, core 212 is to heat to approximately 1040° C.±60° C. for at least four hours and then cooled at a cooling rate of approximately 10° C./hour. This secondary heating and cooling may be carried out a plurality of times. During the heating (and cooling) a suitable mixture of gases are present within the oven. According to preferred embodiments, suitable proportions of O₂, O₃, Cl₂, F₂, and/or noble gases, and/or combinations thereof are present in the atmosphere of the oven. However, during the cooling step(s) the atmosphere may be reduced. This process results in a final core 212, which is highly stable and solarization resistant.

The pure, fused-silica glass core is stable and treated so as to be solarization resistant (i.e., treated to withstand the damaging effects of high energy UV photons). According to an embodiment, the core is solarization resistant and stable with respect to UV photons having a wavelength of 245 nm and below (e.g., down to 1 nm).

According to an embodiment, the light source may include a UV LED that emits light in the UV spectrum, for example between 1 and 400 nm, and also may take the form of an LED 260. According to a preferred embodiment, the light source 260 is a UV-C LED that emits light between approximately 200-245 nm. By implementing a light source with a low wavelength (e.g., 245 nm) bright/hot spots along the length of the optical fiber are further reduced and/or eliminated.

UV-C LEDs provide the advantage of being example generally monochromatic light (±5 nm), which allows UV sterilization system 100 to be tailored to specific wavelengths (and applications) as desired. For example, different microorganisms and pathogens are more vulnerable to different wavelengths of UV light. Similarly, different types of microorganisms and pathogens are known to be prevalent in different aqueous solutions. By modifying the light source wavelength, UV sterilization system 200 may be modified based on the application it is to be used. By way of non-limiting example, a UV-C LED with a wavelength λ₁ may be used when UV sterilization system 200 is implemented in a wastewater treatment plant. In contrast, a UV-C LED with a wavelength λ₂ may be used when UV sterilization system 200 is implemented in a ballast tank of a ship.

Methods of using UV sterilization system 200 may include implementing at least one optical fiber 210 and light source 260 within a fluid supply conduit. According to embodiments, at least one optical fiber 210 is placed within a fluid supply conduit such that the at least one optical fiber 210 traverses at least a section of the fluid supply conduit. According to preferred embodiments, a plurality of optical fibers 210 traverse at least a section of the fluid supply conduit.

Ends of the at least one optical fiber 210 include optical connector couplings. Transport fibers may be attached to the optical connector couplings, which in turn are connected to light source 260 (e.g., a UV-C LED). Enclosures may also be used to encase the optical connector couplings and portions of the optical fiber 210 and transport fibers in order to enhance mechanical protection of the couplings and to protect against environmental factors (e.g., water ingress, rodents. Etc.). According to alternative embodiments, light source 260 may be directly coupled to optical fiber 210 or the optical connector coupling.

UV sterilization system 200 may also include suitable electronic circuitry, including a controller and a power supply for controlling and powering of light source 260. The resulting UV sterilization system 200 is configured to sterilize fluid flowing through the fluid supply conduit by selectively powering light source(s) 260. For example, when power is applied to the light source(s) 260 UV light enters the transport fibers, passes through the optical connector couplings, and subsequently is emitted through optical fiber(s) 210.

As discussed in detail above, optical fiber(s) 210 are configured to homogenously emit light radially along a longitudinal axis of the fiber. In this way, UV sterilization system 200 is specially adapted to emit UV radiation throughout a fluid flowing through the fluid supply conduit, thereby sterilizing the fluid.

The unique design of UV sterilization system 200 allows it to be retrofitted into existing fluid treatment plants. For example, the fluid supply conduit may be sized and shaped to fit to standardized conduit systems currently used in water treatment facilities. In this way, UV sterilization system 200 may be viewed as a plug-in or modular system, as the system may be incorporated (e.g., plugged into) into an existing water treatment conduit system.

### Ambient Lighting

Radiant or ambient lighting is utilized in an array of applications. For example, traditional neon signs utilize glass tubes with neon gas that, when excited, emit radiant lighting. Other types of glass tubes filled with excitable gases have also been known to be implemented for even lighting in a variety of other situations (e.g., interior lighting). However, such lighting devices are often inelastic (e.g., glass tubes), expensive to manufacture, are difficult to maintain, and expend significant energy during use.

As compared to more traditional light transmitting means (e.g., glass tubes), optical fibers are often cheaper, thinner, more flexible, and more compact. As discussed in the background section, traditional optical fibers are configured for transmitting light from a source to a destination. These fibers strive to reduce light loss along the length of the fiber, as such losses would degrade the light signal.

There remains a need for an ambient lighting system that implements optical fibers so as to reduce manufacturing costs and energy requirements, and increase efficiency, creating a flexible, compact, low-maintenance, and cost-effective system.

According to embodiments, an ambient lighting system 300 may include optical fiber 310 and light source 360, which may be similar or the same as optical fiber 110 and 160. Optical fiber 310 may include a core 312, a cladding 314, and a jacket 320. Core 312, cladding 314, and jacket 320 may be same as described above with regard to core 112, cladding 114, and jacket 120. In this way, optical fiber 310 generally take the same form as optical fiber 110.

The at least one light source 360 may comprise an LED, a laser light source, or other suitable light emitting devices. The light source 360 may be coupled to the optical fiber 310 utilizing a low tolerance housing. Alternatively, any suitable means for ensuring that light from the light source enters an input end of the optical fiber may be implemented.

Due to the flexible nature of optical fiber 310, ambient lighting system 300 may be attached to a variety of objects in varying shapes. For example, ambient lighting system 300 may be attached around the perimeter of a bicycle tire, creating a circular lighting device. Ambient lighting system 300 may also be shaped to conform to various spaces (e.g., conduits, recesses, etc.) in various applications (e.g., in automobiles, airplanes, commercial and residential spaces, etc.) depending upon a user's desired implementation. Such an ambient lighting system 300 provides homogenous ambient lighting utilizing minimal space, while also providing the ability to hide the ambient lighting system 300.

Although the optical fibers and light sources are discussed above as being used for specific examples and in specific implementations, the present disclosure is not meant to be so limited. Optical fibers 110 and light sources 160 may be implemented for other uses. For example, optical fibers 110 and light sources 160 may be implemented to simulate UV radiate in test chambers. Additionally, optical fibers 110 and light sources 160 may be implemented in animal husbandry (e.g., fish or chicken breeding) and vertical farming (e.g., greenhouse or hydroponic farming). In all such configurations, optical fibers 110 and light sources 160 provide a low cost, energy efficient, compact, and flexible lighting system capable of providing continuous, homogenous lighting along the entire length of the optical fibers 110.

What is claimed is:

1. An optical fiber, comprising:
a central glass core;
a polymer cladding disposed on and surrounding the core; and
a polymer jacket disposed on and surrounding the cladding,
wherein the cladding comprises:
a polymer substrate; and
a plurality of light scatter structures; and
wherein the cladding is configured to uniformly scatter light radially along a length of the optical fiber.

2. The optical fiber of claim 1,
wherein the central glass core comprises fused silica.

3. The optical fiber of claim 1,
wherein the central glass core has a diameter that ranges from approximately 100 μm to 1500 μm.

4. The optical fiber of claim 1,
wherein the polymer substrate comprises a transparent or translucent polymer; and
wherein the plurality of light scatter structures comprises:
aluminum oxide particles;
titanium oxide particles;
silica particles; or
combinations thereof.

5. The optical fiber of claim 4,
wherein the translucent polymer of the polymer substrate comprises an acrylic polymer.

6. The optical fiber of claim 1,
wherein the cladding has a thickness that ranges from approximately 20 μm to 1700 μm.

7. The optical fiber of claim 4,
wherein the aluminum oxide particles are homogenously dispersed within the polymer substrate along the length of the optical fiber.

8. The optical fiber of claim 1,
wherein the polymer jacket comprises a translucent polymer.

9. The optical fiber of claim 1,
wherein the jacket has a thickness that ranges from approximately 300 μm to 5 mm.

10. The optical fiber of claim 8,
wherein the translucent polymer of the polymer jacket comprises:
ethylene tetrafluoroethylene;
nylon;
polyvinyl chloride;
an acrylate polymer; or
combinations thereof.

11. The optical fiber of claim 1,
wherein the central core does not include any scattering structures.

12. The optical fiber of claim 1,
wherein the optical fiber has a numerical aperture value of approximately 0.37 to 0.5.

13. A lighting system, comprising:
at least one optical fiber, comprising:
a central glass core;
a polymer cladding disposed on and surrounding the core; and
a polymer jacket disposed on and surrounding the cladding,
wherein the cladding comprises:
a polymer substrate; and
a plurality of light scatter structures; and
at least one light source coupled to the at least one optical fiber,
wherein the cladding is configured to uniformly scatter light radially from the at least one light source along a length of the optical fiber.

14. The optical fiber of claim 13,
wherein the at least one light source comprises an LED.

15. A sterilization system, comprising:
at least one optical fiber, comprising:
a central glass core;
a polymer cladding disposed on and surrounding the core; and
a polymer jacket disposed on and surrounding the cladding,
wherein the cladding comprises:
a polymer substrate; and
a plurality of light scatter structures; and
at least one light source coupled to the at least one optical fiber,
wherein the cladding is configured uniformly scatter light radially from the at least one light source along a length of the optical fiber.

16. The optical fiber of claim 15,
wherein the at least one light source comprises an LED configured to emit ultraviolet radiation.

17. The optical fiber of claim 16,
wherein the LED is configured to emit light between approximately 200 and 245 nm.

18. The optical fiber of claim 15,
wherein the central glass core is solarization resistant.
